(19) United States
(12) Patent Application Publication
(10) Pub. No.: US 2024/0019860 A1
(43) Pub. Date: Jan. 18, 2024

(54) ABNORMALITY CAUSE DIAGNOSIS DEVICE AND ABNORMALITY CAUSE DIAGNOSIS METHOD

(71) Applicant: Toshiba Energy Systems & Solutions Corporation, Kawasaki-shi (JP)

(72) Inventors: Kazuki Kobayashi, Yokohama Kanagawa (JP); Reza Akhyar Ramadhan, Yamato Kanagawa (JP); Tsukasa Takeuchi, Yokohama Kanagawa (JP)

(73) Assignee: Toshiba Energy Systems & Solutions Corporation, Kawasaki-shi (JP)

(21) Appl. No.: 18/351,076

(22) Filed: Jul. 12, 2023

(30) Foreign Application Priority Data
Jul. 13, 2022 (JP) 2022-112507

(51) Int. Cl. G05B 23/02

(52) U.S. Cl. CPC G05B 23/0254; G05B 23/0216

(57) ABSTRACT

According to one embodiment, an abnormality cause diagnosis device performs first determination processing of determining whether the operation data satisfies a predetermined condition, when the cause of the abnormality can be specified, displays information representing the cause of the abnormality and the measure associated with the cause, when the cause of the abnormality cannot be specified, displays the question to the user and performs second determination processing of determining whether the non-operation data input to the question via the second input device satisfies a predetermined condition, when the cause of the abnormality can be specified, displays information representing the cause of the abnormality and the measure associated with the cause.

### CROSS-REFERENCE TO RELATED APPLICATIONS

This application is based upon and claims the benefit of priority from Japanese Patent Application No. 2022-112507, filed Jul. 13, 2022, the entire contents of which are incorporated herein by reference.

### FIELD

Embodiments described herein relate generally to an abnormality cause diagnosis device and an abnormality cause diagnosis method.

### BACKGROUND

If an abnormality occurs in one of individual apparatuses that constitute a plant such as a power plant, in general, an operator of the plant or an engineer of an apparatus maker specifies an abnormality cause by conducting investigations, and takes measures for recovery from the abnormality occurrence.

On the other hand, there is known a technique of, without performing investigations and specifying the abnormality cause by the operator or engineer, inputting operation data (for example, data representing a physical quantity such as the rotation speed of a rotating object used in an apparatus, the temperature of a substance, a pressure, or a degree of vacuum) transmitted from each apparatus to a predetermined monitoring system to a unique abnormality cause diagnosis device, thus specifying the cause of an abnormality, and quickly presenting a measure to the operator.

In a case where every time an abnormality occurs in one of the individual apparatuses of a plant, a person specifies the abnormality cause of the apparatus in which the abnormality has occurred, and takes a measure against it, an enormous time and cost are required in many cases. In addition, it is difficult for an unskilled person to correctly specify the abnormality cause and appropriately take a measure.

On the other hand, in the technique using operation data transmitted from each apparatus of a plant to the abnormality cause diagnosis device, since information representing a phenomenon that can be perceived by human sense (for example, information of wear or crack of a component that constitutes an apparatus, abnormal noise, smell, damage, or a past inspection record) is not included in the operation data, it is sometimes impossible to correctly specify the abnormality cause and present an appropriate measure to a user.

Hence, there is a demand for providing an abnormality cause diagnosis device capable of correctly specifying various kinds of abnormality causes in a plant and presenting an appropriate measure and an abnormality cause diagnosis method.

### BRIEF DESCRIPTION OF THE DRAWINGS

FIG. 1 is a view showing an example of the configuration of an abnormality cause diagnosis device that diagnoses an abnormality cause of individual apparatuses that constitute a plant according to the embodiment.

FIG. 2 is a view showing an example of the configuration of a turning device.

FIG. 3 is a view showing an example of various causes of an engagement failure.

FIG. 4A shows views of an example of an operation (first half) by a processing device 4.

FIG. 4B shows views of an example of an operation (second half) by the processing device 4.

FIG. 5 is a view showing an example of a diagnosis screen.

FIG. 6 is a view showing an example of a diagnosis result screen.

FIG. 7A is a view showing a detailed example (1) of a diagnosis screen 11-a shown in FIG. 5 which is displayed in a case where an abnormality of an engagement failure of a turning device is detected.

FIG. 7B is a view showing another detailed example (2) of the diagnosis screen 11-a different from the example shown in FIG. 7A.

FIG. 8 is a view showing a detailed example of a diagnosis result screen 11-b shown in FIG. 6 which is displayed as a diagnosis result in a case where an abnormality of an engagement failure of a turning device is detected.

### DETAILED DESCRIPTION

Embodiments will now be described with reference to the accompanying drawings.

According to one embodiment, there is provided an abnormality cause diagnosis device comprising: a first input device configured to input operation data transmitted from each apparatus that constitutes a plant under operation; a second input device configured to input non-operation data manually input for a question to a user; a processing device configured to specify a cause of an abnormality that occurs in the apparatus and a measure associated, in advance, with the cause of the abnormality based on the operation data and the non-operation data in accordance with a predetermined processing procedure; and an output device configured to display the cause of the abnormality of the apparatus and the measure specified by the processing device. The processing device performs first determination processing of determining whether the operation data satisfies a predetermined condition, when the cause of the abnormality can be specified from a result of the first determination processing, displays, on the output device, information representing the cause of the abnormality and the measure associated with the cause of the abnormality in advance, when the cause of the abnormality cannot be specified from the result of the first determination processing, displays the question to the user on the output device, and performs second determination processing of determining whether the non-operation data input to the question via the second input device satisfies a predetermined condition, when the cause of the abnormality can be specified from a result of the second determination processing, displays, on the output device, information representing the cause of the abnormality and the measure associated with the cause of the abnormality in advance, and when the cause of the abnormality cannot be specified from the result of the second determination processing, performs predetermined display or performs the first determination processing using another operation data.

(Configuration of Abnormality Cause Diagnosis Device 100)

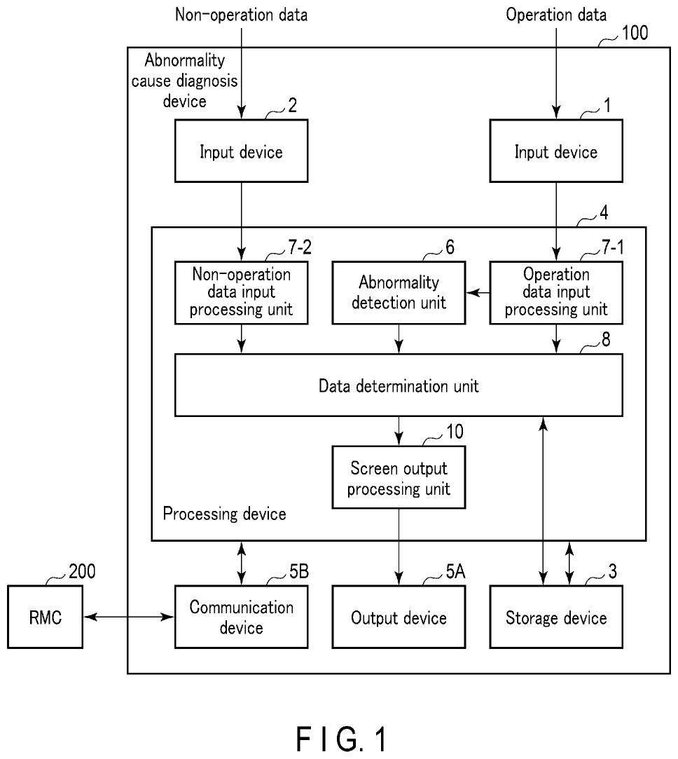

FIG. 1 is a view showing an example of the configuration of an abnormality cause diagnosis device that diagnoses an abnormality cause of individual apparatuses that constitute a plant according to the embodiment.

The abnormality cause diagnosis device 100 shown in FIG. 1 is applied to a plant such as a thermal power plant and has a function of, when an abnormality occurs in one of individual apparatuses that constitute the plant, presenting the cause of the abnormality and a measure associated with the cause in advance to a user such as an operator.

The abnormality cause diagnosis device 100 is implemented by, for example, a computer, and includes, as constituent elements, an input device 1 (first input device), an input device 2 (second input device), a storage device 3, a processing device 4, an output device 5A, and a communication device 5B.

However, the configuration of the abnormality cause diagnosis device 100 is not limited to the example shown in FIG. 1, and can be modified as needed. For example, the input devices 1 and 2 may be configured to be directly connected to the storage device 3. In this case, data from the input device 1 or 2 is directly transmitted to the storage device 3 without interposing the processing device 4. Also, if communication with the outside is not necessary, the communication device 5B may not be installed.

The input device 1 continuously receives data (operation data) transmitted from each apparatus of the plant under operation to a predetermined monitoring system and supplies the received data to the processing device 4 or the storage device 3. The operation data is, for example, data representing a physical quantity such as the rotation speed of a rotor or the degree of vacuum of an exhaust chamber, and identification information of a corresponding apparatus may be added.

The input device 2 is a device having a function (manual input function) of enabling manual input of information by the user. The input device 2 may be implemented in the form of a touch panel or a tablet in combination with, for example, a display. The display in that case may be the output device 5A. The input device 2 receives, for example, data (to be referred to as “non-operation data” hereinafter) manually input by the user to a question to the user displayed from the processing device 4 to the output device 5A, and supplies the received non-operation data to the processing device 4. The non-operation data is, for example, information representing a phenomenon that can be perceived by human sense, such as wear or crack of a component that constitutes an apparatus, abnormal noise, smell, damage, or a past inspection record, and is used particularly to specify an abnormality cause that cannot be found from operation data.

The storage device 3 includes a storage area for storing a program (abnormality cause diagnosis program) used by the processing device 4 to execute processing of abnormality cause diagnosis, a storage area for storing various kinds of information used by the processing device 4 for processing, a storage area for storing data supplied from the input devices 1 and 2, and the like.

The processing device 4 corresponds to a processor, and performs various kinds of information processing by executing the abnormality cause diagnosis program stored in the storage device 3. Note that the abnormality cause diagnosis program may be saved/executed on, for example, a cloud server. Various kinds of information to be used at the time of execution of the abnormality cause diagnosis program may also be saved on the cloud server.

The processing device 4 has functions of storing operation data of each apparatus supplied from the input device 1 or non-operation data supplied from the input device 2 in a corresponding storage area of the storage device 3, detecting an abnormality of an arbitrary apparatus from operation data, obtaining the cause of the detected abnormality in accordance with a predetermined processing procedure using another operation data and/or non-operation data, displaying a question to the user on the output device 5A when obtaining the cause of the detected abnormality, obtaining the cause of the abnormality after obtaining, from the input device 2, non-operation data manually input by the user to the question, and displaying, on the output device 5A, the obtained cause of the abnormality and a measure associated with the cause in advance.

The processing device 4 also has a function of, if it cannot specify the cause of an abnormality alone, communicating, via the communication device 5B, with a Remote Monitoring Center (RMC) 200 located outside the ABNORMALITY cause diagnosis device 100, thereby obtaining the cause of the abnormality from the RMC 200.

The output device 5A corresponds to a display device (display) or a printing device (printer). In this example, a description will be made assuming that the output device 5A is a display.

The communication device 5B performs communication between the processing device 4 and the RMC 200.

(Functional Configuration of Processing Device 4)

The processing device 4 includes, as various kinds of functions, an abnormality detection unit 6, an operation data input processing unit 7-1, a non-operation data input processing unit 7-2, a data determination unit 8, and a screen output processing unit 10.

The abnormality detection unit 6 detects an abnormality that occurs in an apparatus based on the operation data of each apparatus supplied from the operation data input processing unit 7-1, and upon detecting an abnormality, notifies the data determination unit 8 of the abnormality detection.

The operation data input processing unit 7-1 receives the operation data of each apparatus supplied from the input device 1 into the processing device 4, and supplies the received operation data to the abnormality detection unit 6 or the data determination unit 8.

The non-operation data input processing unit 7-2 receives non-operation data supplied from the input device 2 into the processing device 4, and supplies the received non-operation data to the data determination unit 8.

The data determination unit 8 stores the operation data of each apparatus supplied from the operation data input processing unit 7-1 in a corresponding storage area of the storage device 3, or stores non-operation data supplied from the non-operation data input processing unit 7-2 in a corresponding storage area of the storage device 3.

Also, upon receiving an abnormality detection notification from the abnormality detection unit 6, the data determination unit 8 executes a series of processes along a predetermined processing procedure, thereby specifying the cause of an abnormality or specifying a measure associated, in advance, with the specified cause of the abnormality. A detailed example of the processing procedure will be described later in detail.

In addition, the data determination unit 8 supplies the information of the processing procedure to the screen output processing unit 10 to use it as a part of information to be displayed on the output device 5A.

Furthermore, based on the specified cause of the abnormality, the data determination unit 8 specifies the measure associated, in advance, with the cause of the abnormality using information saved as a database stored in the storage device 3. More specifically, the database stores, for example, information including a cause of an abnormality and a measure corresponding to this (to be generically referred to as abnormality diagnosis result information hereinafter), selects a measure corresponding to the cause of an abnormality transmitted from the side of the data determination unit 8, and supplies the cause of the abnormality and the selected measure as abnormality diagnosis result information to the screen output processing unit 10 for screen display.

The screen output processing unit 10 has a function of forming a diagnosis screen (a screen including a question to the user) to be described later and displaying the screen on the output device 5A, or forming a diagnosis result screen (a screen showing the cause of an abnormality and a measure for it) and displaying the screen on the output device 5A.

(Detailed Case)

Next, as a detailed example of abnormality occurrence, a case in which an engagement failure occurs in a turning device that is one of apparatuses constituting a thermal power plant will be described.

In the thermal power plant, when activating or stopping a turbine, it is necessary to gradually apply or remove heat while rotating a rotor at a low speed in consideration of the influence of thermal deformation. The rotation at this time is called turning, and in general, a low-speed rotary operation of a turbine is performed using a turning device.

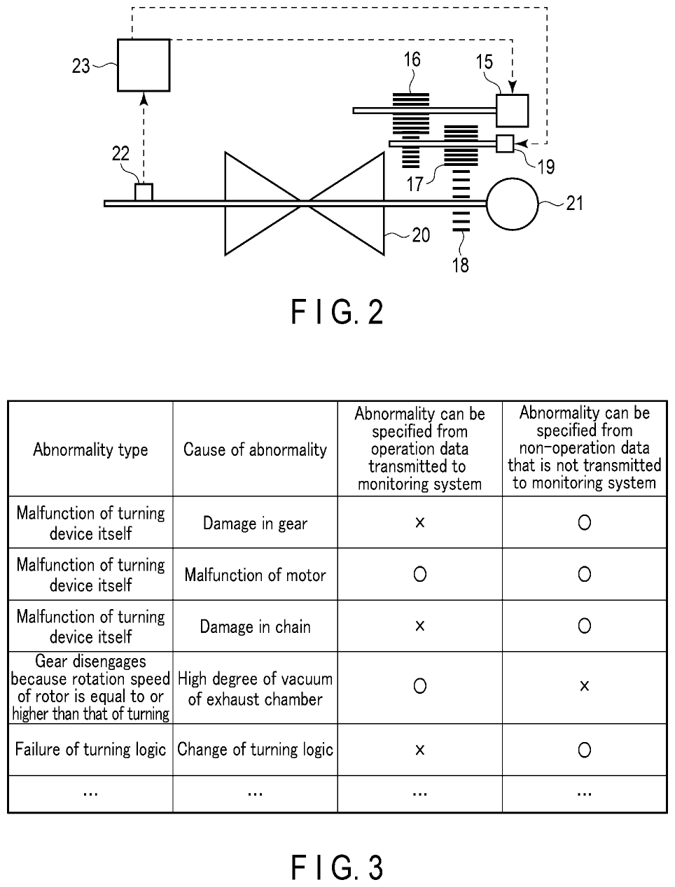

FIG. 2 shows an example of the configuration of the turning device.

A turning motor 15 shown in FIG. 2 is an electric motor using an AC motor as a driving device. A gear 16 connected to the shaft of the turning motor 15 is connected, via a deceleration gear 17, to a spacer gear 18 on the rotor side by a clutch 19, and the apparatus is configured to transmit the torque of the turning motor 15 to the rotating shaft of a turbine 20 and a generator 21 to rotate the rotor. On the turbine 20, a rotation speed detector 22 capable of detecting the rotation speed of the rotor or the presence/absence of rotation is installed. A control device 23 controls activation/stop of the turning motor 15 and engagement/disengagement of the clutch 19 based on a detection signal from the rotation speed detector 22.

In such a configuration, for example, the control device 23 activates the turning motor 15 and then stops it immediately, and in the process of decreasing the rotation speed of the turning motor 15, operates the clutch 19 to cause the deceleration gear 17 to mesh with the spacer gear 18 and execute a turning operation. At this time, a phenomenon called an engagement failure that the deceleration gear 17 of the turning device cannot mesh with the spacer gear 18 and disengages may occur.

In a case of stop from a normal operation, a turning operation by the turning device needs to be always executed to prevent deformation of the turbine. Hence, once an engagement failure occurs, it may be impossible to evenly remove heat in the turbine 20, and apparatus damage may occur due to thermal deformation. In addition, enormous cost and time may be needed to do unplanned cause investigation, measure examination, and adjustment works for recovery.

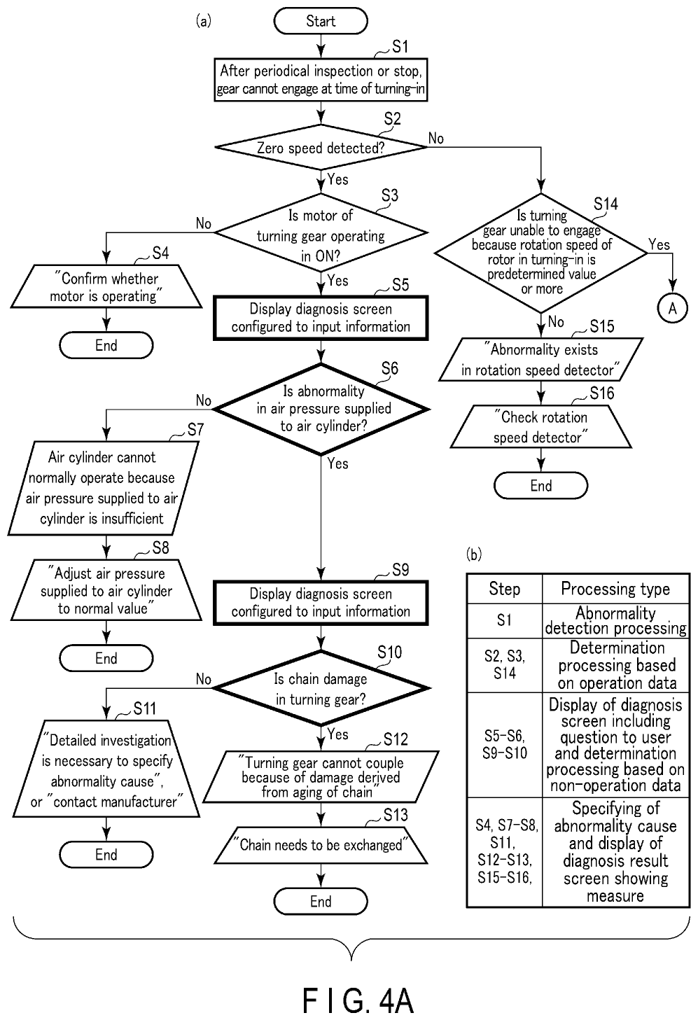

There are various possible causes of an engagement failure. FIG. 3 shows an example of various causes of an engagement failure.

Phenomena (abnormality types) of an engagement failure are as follows.
A malfunction of the turning device itself

Causes of this abnormality are damage in a gear, malfunction of a motor, damage in a chain, and the like.
A phenomenon that the deceleration gear 17 disengages because the rotation speed of the rotor is higher than the rotation speed of the deceleration gear 17

A cause of this abnormality is a high degree of vacuum of the exhaust chamber (a state in which the degree of vacuum is a predetermined value or more), or the like.
A failure of a logic

A cause of this abnormality is a change of a turning logic, or the like.

The various kinds of phenomena described above can be classified into a case where an abnormality cause can be specified from operation data (for example, data such as the current value of the turning motor 15 or the degree of vacuum of the exhaust chamber) transmitted to the monitoring system and a case where an abnormality cause can be specified from non-operation data (for example, information representing a phenomenon that can be perceived by human sense, such as a visually recognizable gear damage state or chain break state or confirmation of a change history of the turning logic) that is not transmitted to the monitoring system, as indicated by ∘ in FIG. 3.

However, the various kinds of phenomena described above include an abnormality whose cause cannot be specified from operation data transmitted to the monitoring system and an abnormality whose cause cannot be specified from non-operation data that is not transmitted to the monitoring system, as indicated by x in FIG. 3.

It can be said from these that to specify the cause of the engagement failure of the turning device, the cause of the engagement failure is preferably investigated by complexly combining two types of data, that is, operation data that is transmitted to the monitoring system and non-operation data that is not transmitted to the monitoring system.

### Example of Flowchart

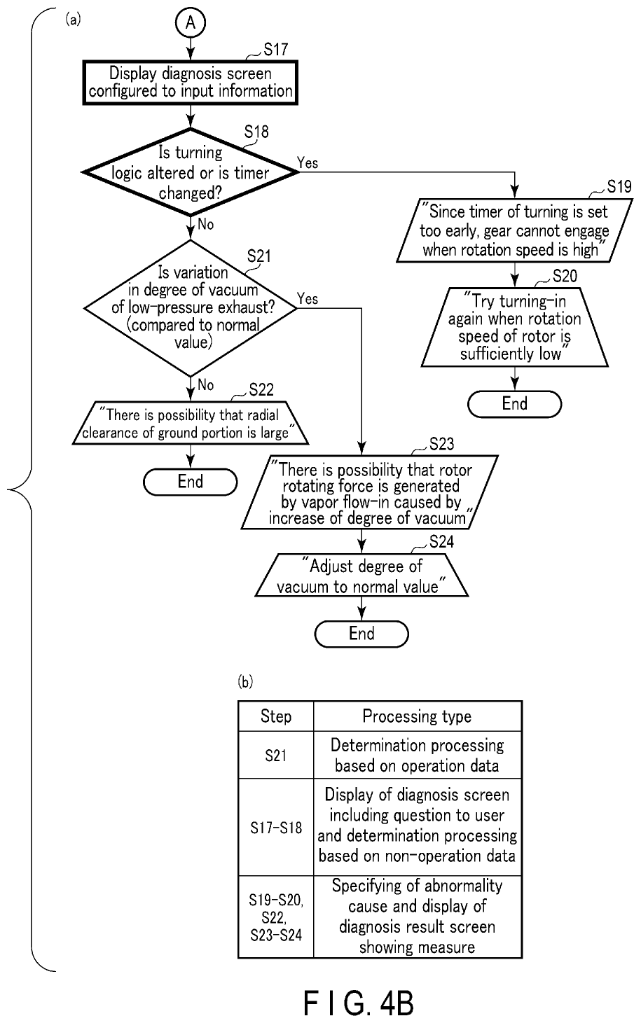

An example of an operation by the processing device 4 in FIG. 1 will be described next with reference to FIGS. 4A and 4B.

Here, an example of a flowchart applied to an operation at the time of the occurrence of an engagement failure of the turning device shown in the above case will be described.

Steps shown in the flowcharts of FIGS. 4A(a) and 4B(a) can be classified for each processing type, as shown in the tables of FIGS. 4A(b) and 4B(b).

That is, the steps shown in the flowcharts of FIGS. 4A(a) and 4B(a) are classified into four types to be described below.

1. “Abnormality Detection Processing”

Step S1 in FIG. 4A corresponds to abnormality detection processing. “Abnormality detection processing” is processing of the abnormality detection unit 6 detecting, based on operation data of each apparatus supplied from the operation data input processing unit 7-1, an abnormality that occurs in an apparatus.

2. “Determination Processing Based on Operation Data” (First Determination Processing)

Steps S2, S3, and S14 in FIG. 4A and step S21 in FIG. 4B correspond to “determination processing based on operation data”.

“Determination processing based on operation data” is processing (first determination processing) of the data determination unit 8 determining whether “operation data” satisfies a predetermined condition to specify the cause of the abnormality detected by the abnormality detection unit 6.

If the cause of the abnormality can be specified from the result of the first determination processing, “specifying of abnormality cause and display of diagnosis result screen showing measure” (for example, the processing of steps S4, and S15 and S16 in FIG. 4A or the processing of steps S22, and S23 and S24 in FIG. 4B) to be described later is performed. On the other hand, if the cause of the abnormality cannot be specified from the result of the first determination processing, “display of diagnosis screen including question to user” and “determination processing based on non-operation data” (for example, the processing of steps S5 and S6, and S9 and S10 indicated by thick frames in FIG. 4A or the processing of steps S17 and S18 indicated by thick frames in FIG. 4B) to be described later are performed.

3. “Display of Diagnosis Screen Including Question to User” and “Determination Processing Based on Non-Operation Data” (Second Determination Processing)

Steps S5 and S6, and S9 and S10 indicated by thick frames in FIG. 4A and steps S17 and S18 indicated by thick frames in FIG. 4B correspond to “display of diagnosis screen including question to user” and “determination processing based on non-operation data”. More specifically, steps S5, S9, and S17 correspond to “display of diagnosis screen including question to user”, and steps S6, S10, and S18 correspond to “determination processing based on non-operation data”.

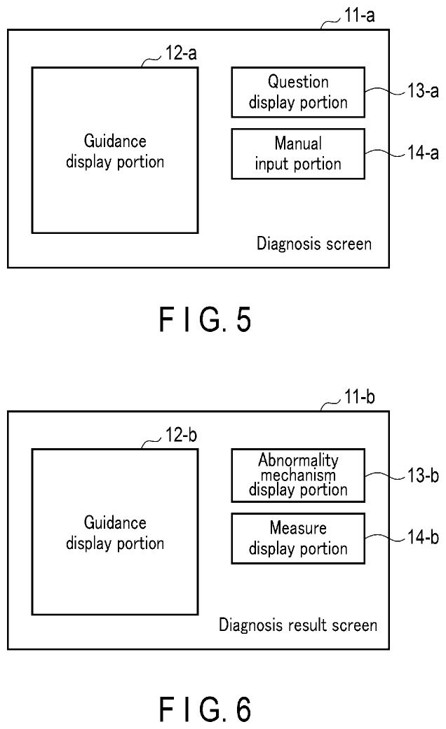

“Display of diagnosis screen including question to user” is processing of the screen output processing unit 10 displaying, on the output device 5A, a diagnosis screen including a question to the user in a case where the cause of an abnormality cannot be specified from the result of the first determination processing. The diagnosis screen at this time is displayed in a form shown in FIG. 5. Note that details of the diagnosis screen shown in FIG. 5 will be described later.

“Determination processing based on non-operation data” is processing (second determination processing) of the data determination unit 8 determining whether non-operation data (that is, non-operation data supplied from the non-operation data input processing unit 7-2) input by the user to the question via the input device 2 satisfies a predetermined condition.

If the cause of the abnormality can be specified from the result of the second determination processing, “specifying of abnormality cause and display of diagnosis result screen showing measure” (for example, the processing of steps S7 and S8, and S12 and S13 in FIG. 4A or the processing of steps S19 and S20 in FIG. 4B) to be described later is performed. On the other hand, if the cause of the abnormality cannot be specified from the result of the second determination processing, predetermined display (for example, the processing of step S11 in FIG. 4A) to be described later is performed, or first determination processing (for example, the determination processing of step S21 in FIG. 4B) using another operation data is performed to continuously specify the cause of the abnormality.

4. “Specifying of Abnormality Cause and Display of Diagnosis Result Screen Showing Measure”

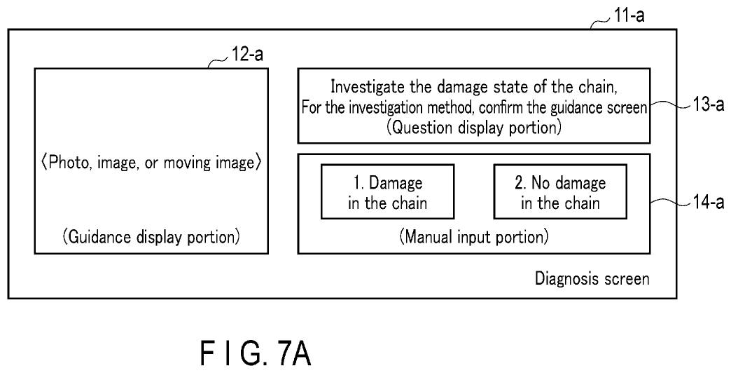

Steps S4, S11, S12 and S13, and S15 and S16 in FIG. 4A and steps S19 and S20, S22, and S23 and S24 in FIG. 4B correspond to “specifying of abnormality cause and display of diagnosis result screen showing measure”. However, in step S11, since the abnormality cause cannot be specified, “diagnosis result screen showing measure” without showing an abnormality cause is displayed. The diagnosis result screen at this time is displayed in a form shown in FIG. 6. Note that details of the diagnosis result screen shown in FIG. 6 will be described later.

“Specifying of abnormality cause and display of diagnosis result screen showing measure” performed in steps S4, S15 and S16, S22, and S23 and S24 is processing performed in a case where the cause of the abnormality can be specified from the result of the first determination processing.

“Specifying of abnormality cause and display of diagnosis result screen showing measure” performed in steps S7 and S8, S12 and S13, and S19 and S20 is processing performed in a case where the cause of the abnormality can be specified from the result of the second determination processing.

“Display of diagnosis result screen showing measure” performed in step S11 is processing performed in a case where the cause of the abnormality cannot be specified either from the result of the first determination processing or from the result of the second determination processing.

During the operation of the plant, operation data transmitted from the apparatuses (including the above-described turning device) to the predetermined monitoring system is transmitted to the abnormality cause diagnosis device 100 as well, and sent to the processing device 4 via the input device 1 and simultaneously stored in the storage device 3. In the processing device 4, the operation data input from the input device 1 is transmitted to the abnormality detection unit 6 via the operation data input processing unit 7-1.

For example, assume that when activating the turbine after periodical inspection or stop of the thermal power plant, an abnormal situation that the deceleration gear 17 cannot engage with the spacer gear 18 at the time of turning-in using the turning device occurs. At this time, operation data on which the abnormality is reflected is transmitted to the abnormality detection unit 6.

In step S1 of FIG. 4A, the abnormality detection unit 6 detects the abnormality.

From then on, the data determination unit 8 performs determination processing for the abnormality, and the screen output processing unit 10 performs display processing of the diagnosis screen shown in FIG. 5 or the diagnosis result screen shown in FIG. 6.

In step S2, it is determined, based on corresponding operation data (for example, the operation data of the rotation speed detector), whether it is a zero-speed state (=a state in which the rotor is barely rotating). If it is a zero-speed state (YES), the process advances to step S3. On the other hand, if it is not a zero-speed state (NO), the process advances to step S14.

In step S3, it is determined, based on corresponding operation data, whether the motor of the turning device is normally operating.

In step S4, the diagnosis result screen shown in FIG. 6 including a message showing an abnormality cause/measure, such as “the motor of the turning device is not normally operating” or “confirm whether the motor is operating” is displayed on the output device 5A.

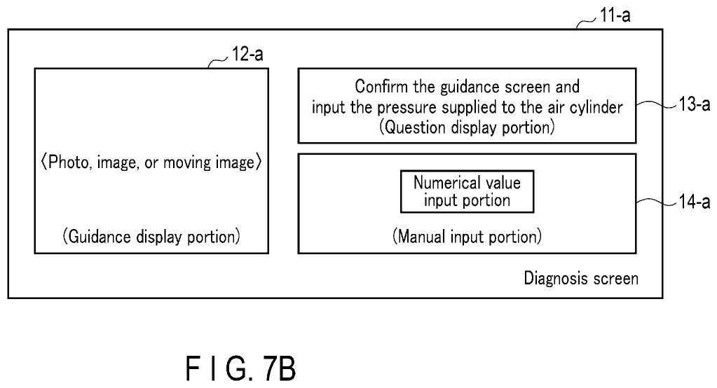

In step S5, the diagnosis screen shown in FIG. 5 including a question to the user is displayed on the output device 5A. Here, a diagnosis screen including not only a message that requests confirming whether an abnormality exists in an air pressure supplied to an air cylinder but also a message that urges the user to answer by manually inputting the presence/absence of an abnormality is displayed on the output device 5A. More specifically, contents shown in FIG. 7B are displayed. FIG. 7B will be described later.

In step S6, it is determined, based on data (non-operation data) input via the input device 2 by manual input of the user, whether an abnormality exists in the air pressure supplied to the air cylinder. If an abnormality exists (YES), the process advances to step S9. On the other hand, if no abnormality exists (NO), the process advances to step S7.

In steps S7 and S8, the diagnosis result screen shown in FIG. 6 including not only a message showing an abnormality cause, such as “the air cylinder cannot normally operate because the air pressure supplied to the air cylinder is insufficient” but also a message showing a measure, such as “adjust the air pressure supplied to the air cylinder to a normal value” is displayed on the output device 5A.

In step S9, the diagnosis screen shown in FIG. 5 including a question to the user is displayed on the output device 5A. Here, a diagnosis screen including not only a message that requests confirming whether the chain of a turning gear is damaged but also a message that urges the user to answer by manually inputting the presence/absence of damage is displayed on the output device 5A. More specifically, contents shown in FIG. 7A are displayed. FIG. 7A will be described later.

In step S10, it is determined, based on data (non-operation data) manually input by the user via the input device 2, whether damage (break or the like) exists in the chain of the turning gear. If damage exists (YES), the process advances to step S12. If damage does not exist (NO), the process advances to step S11.

In step S11, the diagnosis result screen shown in FIG. 6 including a message showing a measure, such as “detailed investigation is necessary to specify the abnormality cause” or “contact the manufacturer of the apparatus”, is displayed on the output device 5A.

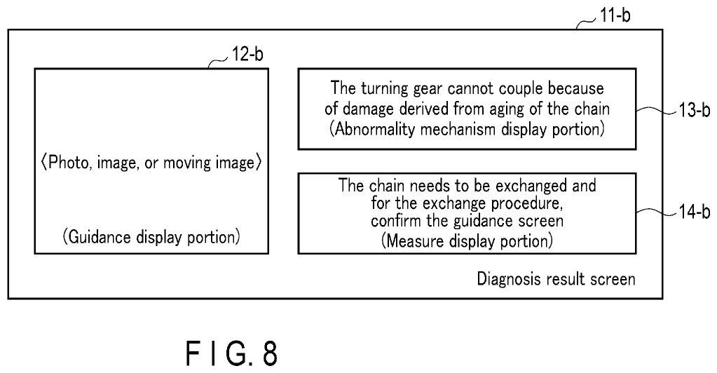

In steps S12 and S13, the diagnosis result screen shown in FIG. 6 including not only a message showing an abnormality cause, such as “the turning gear cannot engage because of damage derived from aging of the chain” but also a message showing a measure, such as “the chain needs to be exchanged” is displayed on the output device 5A. More specifically, contents shown in FIG. 8 are displayed. FIG. 8 will be described later.

In step S14, it is determined, based on corresponding operation data, whether the turning gear cannot engage in a state in which the rotor at the time of turning-in is rotating at a rotation speed of a predetermined value or more. If the turning gear cannot engage in that state (YES), the process advances to step S17 in FIG. 4B. On the other hand, if the turning gear cannot engage not in that state (NO), the process advances to step S15.

In steps S15 and S16, the diagnosis result screen shown in FIG. 6 including not only a message showing an abnormality cause, such as “an abnormality exists in the rotation speed detector” but also a message showing a measure, such as “check the rotation speed detector” is displayed on the output device 5A.

In step S17 of FIG. 4B, the diagnosis screen shown in FIG. 5 including a question to the user is displayed on the output device 5A. Here, the diagnosis screen shown in FIG. 5 including not only a message that requests confirming, from the history, whether the activation logic of the turning device has been altered in the past or the timer is changed but also a message that urges the user to answer by manually inputting the presence/absence of the alteration or change is displayed on the output device 5A.

In step S18, it is determined, based on data (non-operation data) manually input by the user via the input device 2, whether the activation logic of the turning device has been altered in the past or the timer is changed. If the alteration or change exists (YES), the process advances to step S19. On the other hand, if the alteration or change does not exist (NO), the process advances to step S21.

In steps S19 and S20, the diagnosis result screen shown in FIG. 6 including not only a message showing an abnormality cause, such as “since the timer of turning is set too early, the gear cannot engage when the rotation speed of the rotor is high” but also a message showing a measure, such as “try turning-in again when the rotation speed of the rotor is sufficiently low” is displayed on the output device 5A.

In step S21, it is determined, based on corresponding operation data, whether there exists a variation in the degree of vacuum of the low-pressure exhaust chamber (whether there exists a variation equal to or more than a threshold as compared to a normal value). If the variation exists (YES), the process advances to step S23. On the other hand, if the variation does not exist (NO), the process advances to step S22.

In step S22, the diagnosis result screen shown in FIG. 6 including message showing an abnormality cause/measure, such as “there is the possibility that the radial clearance of the ground portion is large” and “adjust the radial clearance of the ground portion”, is displayed on the output device 5A.

In steps S23 and S24, the diagnosis result screen shown in FIG. 6 including not only a message showing an abnormality cause, such as “there is the possibility that a rotor rotating force is generated by vapor flow-in caused by an increase of the degree of vacuum” but also a message showing a measure, such as “adjust the degree of vacuum to a normal value” is displayed on the output device 5A.

As described above, the cause of an engagement failure is investigated by complexly combining two types of data, that is, operation data that is transmitted to the monitoring system and non-operation data that is not transmitted to the monitoring system (for example, information representing a phenomenon that can be perceived by human sense, such as a visually recognizable gear damage state or chain break state or confirmation of a change history of the turning logic), thereby correctly specifying the cause of an abnormality and presenting an appropriate measure to the user.

This makes it possible to, for example, specify an abnormality cause (for example, damage caused by aging of a component) that cannot be specified only using operation data and present an appropriate measure, and also specify an abnormality cause (for example, an extremely short setting time of the timer) that cannot be specified only using non-operation data and present an appropriate measure.

In addition, a series of processes from abnormality occurrence to specifying of the cause is displayed on a screen in a flowchart format (for example, the main part of the flowcharts shown in FIGS. 4A and 4B is displayed, and associated processing steps are highlighted), or the cause and mechanism of an abnormality and a measure for recovery handling are made easily understandable for the user by displaying a moving image, related materials, information about exchange components, and the like on the screen. Furthermore, it is possible to implement know-how transfers to handle quick recovery from a trouble in each apparatus of the plant and handle a trouble.

(Diagnosis Screen 11-a and Diagnosis Result Screen 11-b)

FIG. 5 is a view showing an example of the diagnosis screen. FIG. 6 is a view showing an example of the diagnosis result screen.

The diagnosis screen 11-a shown in FIG. 5 includes a guidance display portion 12-a (first display portion), a question display portion 13-a (second display portion), and a manual input portion 14-a (third display portion).

The guidance display portion 12-a is a portion that displays a photo, an image, or a moving image of an apparatus in which an abnormality is detected. A point to be investigated in the apparatus or a confirmation point of a periodical inspection record is displayed in the guidance display portion 12-a. The question display portion 13-a is a portion that displays a question to the user. The manual input portion 14-a is a portion where the user can manually input an answer to the question. The user can execute investigation of the designated point based on the information in the guidance display portion 12-a and the question display portion 13-a, and input the result of the investigation in the manual input portion 14-a.

The diagnosis result screen 11-b shown in FIG. 6 includes a guidance display portion 12-b (fourth display portion), an abnormality mechanism display portion 13-b (fifth display portion), and a measure display portion 14-b (sixth display portion).

The guidance display portion 12-b is a portion that displays a photo, an image, or a moving image for explaining the abnormality cause or measure of an apparatus in which an abnormality is detected. The abnormality mechanism display portion 13-b is a portion that displays an explanation of the cause and mechanism of an abnormality. The measure display portion 14-b is a portion that displays an explanation of a measure to an abnormality.

In the guidance display portion 12-b, using a moving image or an image, an explanation may be made for the user in a way easy to understand by displaying a moving image or a work manual showing a detailed mechanism of an abnormality cause, a measure to the abnormality, or a recovery method. Also, in the guidance display portion 12-b, a report or a reference literature associated with a similar abnormality case in the past may be displayed.

For example, if a question to the user needs to be made, the screen output processing unit 10 shown in FIG. 1 forms the diagnosis screen 11-a including the question and displays the screen on the output device 5A. Also, the screen output processing unit 10 displays, on the output device 5A, the diagnosis result screen 11-b using abnormality diagnosis result information supplied from the data determination unit 8 and the information of the processing procedure. In this case, in the guidance display portion 12-b of the diagnosis result screen 11-b, the screen output processing unit 10 may schematically display the processing procedure, and also display information representing which processing step in the processing procedure has been performed to specify the cause of the abnormality (that is, information showing a processing procedure from the start of diagnosis until obtaining of the diagnosis result in the flowchart format). This allows the user to visually confirm the causal relationship leading to the specifying of the cause of the abnormality.

### (Detailed Example of Diagnosis Screen 11-a (1))

FIG. 7A is a view showing a detailed example (1) of the diagnosis screen 11-a shown in FIG. 5, which is displayed a case where the abnormality of an engagement failure in the turning device is detected, and corresponds to steps S9 and S10 in the flowchart of FIG. 4A.

FIG. 7A shows an example of a screen configured to, in a case where the abnormality of an engagement failure in the turning device is detected, ask the user whether the abnormality cause is damage in the chain.

The guidance display portion 12-a displays a photo, an image, or a moving image of the turning device in which the abnormality of an engagement failure is detected. Here, the display is done to show a point to be investigated in the chain. The question display portion 13-a displays, for example, a message such as “investigate the damage state of the chain” or “for the investigation method, confirm the guidance screen” as the question to the user. The manual input portion 14-a displays a plurality of choices as the candidates of an answer to the question such that the user can easily make an answer to the question. For example, pieces of information such as “1. damage in the chain” and “2. no damage in the chain” are displayed as the plurality of choices. The user can execute investigation of the chain based on the information in the guidance display portion 12-a and the question display portion 13-a, and easily manually input an answer in the manual input portion 14-a based on the result of the investigation.

### (Detailed Example of Diagnosis Screen 11-a (2))

FIG. 7B is a view showing another detailed example (2) of the diagnosis screen 11-a different from the example shown in FIG. 7A, and corresponds to steps S5 and S6 in the flowchart of FIG. 4A.

FIG. 7B shows an example of a screen configured to make a question to the user concerning the value of the pressure supplied to the air cylinder, which is displayed on a measurement instrument at site.

The guidance display portion 12-a displays a photo, an image, or a moving image of the air cylinder in which the abnormality is detected. Here, the display is done to show a point to be investigated. The question display portion 13-a displays, for example, a message such as “confirm the guidance screen” or “input the pressure supplied to the air cylinder” as the question to the user. The manual input portion 14-a displays a region where a numerical value can be input as an answer to the question such that the user can easily make an answer to the question. The user can confirm the value of the pressure supplied to the air cylinder, which is displayed on the measurement instrument at site, based on the information in the guidance display portion 12-a and the question display portion 13-a, and easily manually input the value in the manual input portion 14-a.

### Detailed Example of Diagnosis Result Screen 11-b

FIG. 8 is a view showing a detailed example of the diagnosis result screen 11-b shown in FIG. 6, which is displayed as a diagnosis result in a case where the abnormality of an engagement failure in the turning device is detected, and corresponds to steps S12 and S13 in the flowchart of FIG. 4A.

FIG. 8 shows an example of a screen in a case where the cause of the engagement failure in the turning device is damage in the chain.

The guidance display portion 12-b displays a photo, an image, or a moving image for explaining the cause of the engagement failure in the turning device or a measure. Here, the display is done to show a point of the chain assumed to have damage. The abnormality mechanism display portion 13-b displays an explanation such as “the turning gear cannot couple because of damage derived from aging of the chain” as the cause and mechanism of the abnormality. The measure display portion 14-b displays an explanation such as “the chain needs to be exchanged” or “for the exchange procedure, confirm the guidance screen” as the measure to the abnormality. At this time, the guidance display portion 12-b may display a guidance associated with an associated literature, a procedure of chain exchange, or an ordering method of the exchange component.

Also, the guidance display portion 12-b may schematically display the processing procedure, and also display information representing which processing step in the processing procedure has been performed to specify the chain damage (that is, information showing a processing procedure from the start of diagnosis until obtaining of the diagnosis result in the flowchart format).

### Example Using RMC 200

For example, if an apparatus abnormality that the user has never experienced, an unexpected apparatus abnormality, or an apparatus abnormality caused by complex causes occurs, it may be impossible to specify the cause of the abnormality only by the above-described abnormality cause diagnosis device 100. In this case, the cause of the abnormality may be specified by communication with the RMC 200 described above.

The RMC 200 is the service engineering center of an apparatus manufacturer, and service engineers of the apparatus manufacturer are always on duty. The user can inquire with a service engineer of the apparatus manufacturer about the cause or measure of an abnormality in an apparatus in real time and give a necessary treatment by communicating with the RMC 200 from the abnormality cause diagnosis device 100. At this time, the service engineer of the apparatus manufacturer on the side of the RMC 200 may be allowed to confirm information input to the abnormality cause diagnosis device 100 or the flowchart of abnormality diagnosis in real time via a cloud server. The service engineer performs an abnormality cause specifying work based on the information, thereby quickly presenting an additional investigation of the abnormality cause or recovery handling to the user. Hence, even a user with little knowledge of the apparatus can easily understand the cause and mechanism of an abnormality and a measure thereto.

### Conclusion

As described above in detail, according to this embodiment, for example, it is possible to specify an abnormality cause (for example, damage caused by aging of a component) that cannot be specified only using operation data and present an appropriate measure, and also specify an abnormality cause (for example, an extremely short setting time of the timer) that cannot be specified only using non-operation data and present an appropriate measure.

In addition, a series of processes from abnormality occurrence to specifying of the cause is displayed on a screen in a flowchart format (for example, the main part of the flowchart is displayed, and associated processing steps are highlighted), or the cause and mechanism of an abnormality and a measure for recovery handling are made easily understandable for the user by displaying a moving image, related materials, information about exchange components, and the like on the screen. Furthermore, it is possible to implement know-how transfers to handle quick recovery from a trouble in each apparatus of the plant and handle a trouble.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made. The accompanying claims and their equivalents are intended to cover such forms or modifications as would fall within the scope of the inventions.

What is claimed is:

1. An abnormality cause diagnosis device comprising:
a first input device configured to input operation data transmitted from each apparatus that constitutes a plant under operation;
a second input device configured to input non-operation data manually input for a question to a user;
a processing device configured to specify a cause of an abnormality that occurs in the apparatus and a measure associated, in advance, with the cause of the abnormality based on the operation data and the non-operation data in accordance with a predetermined processing procedure; and
an output device configured to display the cause of the abnormality of the apparatus and the measure specified by the processing device,
wherein the processing device
performs first determination processing of determining whether the operation data satisfies a predetermined condition,
when the cause of the abnormality can be specified from a result of the first determination processing, displays, on the output device, information representing the cause of the abnormality and the measure associated with the cause of the abnormality in advance,
when the cause of the abnormality cannot be specified from the result of the first determination processing, displays the question to the user on the output device, and performs second determination processing of determining whether the non-operation data input to the question via the second input device satisfies a predetermined condition,
when the cause of the abnormality can be specified from a result of the second determination processing, displays, on the output device, information representing the cause of the abnormality and the measure associated with the cause of the abnormality in advance, and
when the cause of the abnormality cannot be specified from the result of the second determination processing, performs predetermined display or performs the first determination processing using another operation data.

2. The device according to claim 1, wherein the processing device displays, on the output device, a diagnosis screen including a first display portion including at least one of a photo, an image, and a moving image of the apparatus in which the abnormality is detected, a second display portion including the question, and a third display portion in which the user can manually input an answer to the question.

3. The device according to claim 2, wherein the processing device displays, in the third display portion, a plurality of choices as candidates of the answer to the question.

4. The device according to claim 2, wherein the processing device displays, in the third display portion, a region where a numerical value can be input as the answer to the question.

5. The device according to claim 1, wherein the processing device displays, on the output device, a diagnosis result screen including a fourth display portion including at least one of a photo, an image, and a moving image of the apparatus in which the abnormality is detected, a fifth display portion including an explanation of the cause and a mechanism of the abnormality, and a sixth display portion including an explanation of the measure to the abnormality.

6. The device according to claim 5, wherein on the diagnosis result screen, the processing device schematically displays the predetermined processing procedure, and displays information representing which processing step in the predetermined processing procedure has been performed to specify the cause of the abnormality.

7. The device according to claim 1, wherein when the cause of the abnormality cannot be obtained by the predetermined processing procedure, the processing device communicates, via a communication device, with a remote monitoring center located outside the abnormality cause diagnosis device, thereby obtaining the cause of the abnormality from the remote monitoring center.

8. An abnormality cause diagnosis method comprising:
inputting, by a first input device, operation data transmitted from each apparatus that constitutes a plant under operation;
inputting, by a second input device, non-operation data manually input for a question to a user;
specifying, by a processing device, a cause of an abnormality that occurs in the apparatus and a measure associated, in advance, with the cause of the abnormality based on the operation data and the non-operation data in accordance with a predetermined processing procedure; and
displaying, by an output device, the cause of the abnormality of the apparatus and the measure specified by the processing device,
wherein processing by the processing device includes:
performing first determination processing of determining whether the operation data satisfies a predetermined condition;
when the cause of the abnormality can be specified from a result of the first determination processing, displaying, on the output device, information representing the cause of the abnormality and the measure associated with the cause of the abnormality in advance;
when the cause of the abnormality cannot be specified from the result of the first determination processing, displaying the question to the user on the output device, and performing second determination processing of determining whether the non-operation data input to the question via the second input device satisfies a predetermined condition;
when the cause of the abnormality can be specified from a result of the second determination processing, displaying, on the output device, information representing the cause of the abnormality and the measure associated with the cause of the abnormality in advance; and
when the cause of the abnormality cannot be specified from the result of the second determination processing, performing predetermined display or performing the first determination processing using another operation data.
